(19) United States
(12) Patent Application Publication
(10) Pub. No.: US 2010/0021651 A1
(43) Pub. Date: Jan. 28, 2010

(54) Method of producing processed rolled materials and system therefor

(76) Inventors: Geoffrey Baldwin, Mechanicsville, VA (US); Brian Baldwin, Richmond, VA (US)

Correspondence Address: FLYNN THIEL BOUTELL & TANIS, P.C., 2026 RAMBLING ROAD, KALAMAZOO, MI, 49008-1631, US

(21) Appl. No.: 12/220,153

(22) Filed: Jul. 22, 2008

(51) Int. Cl. B01J 19/08; B05C 11/00

(52) U.S. Cl. 427/535; 118/708

(57) ABSTRACT

A method of continuously transferring a web of material from a large roll to a smaller roll involves the performance of at least one processing step including printing during the continuous transfer of the web of material from the large roll to the smaller roll. A system for performing the method continuously transfers a web of material from a large roll to a smaller roll while performing at least one processing step on the web of material during the continuous transfer thereof.

### FIELD OF THE INVENTION

The field of the present invention relates to a method and system for continuously transferring a web of material from a large roll to a smaller roll and, more specifically, a method and a system for performing at least one processing step including printing on a web of material while transferring the web of material from a large roll to a small roll.

### BACKGROUND OF THE INVENTION

It is common in the industry to transfer a web of material from a large roll to a smaller roll. In the paper industry, parent rolls are typically transported to an unwind station for unwinding and further processing. Conventional unwind stations or systems known as “unwinds” unwind the parent rolls for calendering, slitting, embossing, printing, ply-bonding, perforating and other conversion and finishing operations. Once the web material or sheets of the unwound parent rolls have been subjected to various conversion and finishing operations, the sheets are then re-wound into retail-size logs, cut and packaged as consumer-size rolls. Due to the need to start and stop the web when converting small rolls, these converting processes are uneconomical to perform while winding small rolls.

Other web material, such as fabrics, films, felts, and other rolling materials and roll composites are similarly unwound from large parent rolls to smaller rolls and subjected to a processing step in the same fashion as discussed above for papers. That is, the web material is unwound from the large parent roll, then subjected to at least one processing step and then rewound onto smaller rolls in at least two separate batch operations. This results in increasing the cost of the final product due to the necessary additional manufacturing steps, people and associated transportation costs.

A traditional method for printing on a web of material is shown in U.S. Pat. No. 4,960,048. In this patent, offset printing presses are used to print on a web material as it is transferred from a first roll to a second roll of similar size or from a web folded in a “stacked sheet” configuration both before and after the printing step. However, this reference would still involve another processing step in transferring the printed roll to a smaller roll.

U.S. Pat. No. 6,740,200 to Seymour et al discloses a method and system for manufacturing and finishing web products at a high speed without reeling and unwinding. In this reference, a web is formed on a forming apparatus, continuously transferred to a conveyor, a converting step performed on the web while the web is continuously supported and advanced on the conveyor and the web finished into a product ready for packaging. The object of this reference is to eliminate the parent roll and its associated reeling and unwinding steps by directly coupling a web-forming machine to converting stations and a winder to make finished roll products.

U.S. Pat. No. 7,004,220 to Rasmussen discloses a machine for transfer pattern printing of a textile web in which a textile web to be printed is wound off an unwind roll, brought into contact with a pattern-containing web, a die transferred from the pattern-containing web to the textile web and the textile and the pattern-containing web then being wound on rolling-up rolls. However, there is no disclosure in this reference regarding transferring a web material from a large roll to a small roll continuously while performing a processing step thereon.

U.S. Pat. No. 7,178,458 to Bates discloses a method of making transferred printing webbing in which a design is printed on a continuous roll paper with die transfer ink using a die transfer printer controlled by a personal computer during which a wide web is unwound from a roll, slit into a plurality of narrower webs which are then received in a receptacle. However, as of today, there is no conventional method for economically and continuously transferring a web material from a large roll to a small roll while performing a processing step including printing thereon.

Therefore, it is an object of the present invention to provide a method and system which can continuously transfer a web of material from a large roll to a small roll while performing a processing step thereon including printing in an economical and efficient manner.

### SUMMARY OF THE INVENTION

The object of the present invention is achieved by providing a method of continuously transferring a web of material from a large roll to a small roll while performing a processing step thereon including printing by utilizing a means for controlling the tension, accumulation and transfer speed of the web of material during the processing step.

The object of the present invention is also accomplished by providing a system for continuously transferring a web of material from a large roll to a small roll while performing at least one processing step on the web of material comprising an unwinder for removing the web of material from a parent roll, at least one processing station for performing at least one processing step on the web of material, an accumulator for controlling the tension of the web of material during the performing of the at least one processing step including printing and a winder for transferring the processed web of material onto a smaller roll.

### BRIEF DESCRIPTION OF THE DRAWINGS

FIG. 1 is a side view of an embodiment of a system according to the present invention;

FIG. 2 is a plan view of a portion of an embodiment of the system according to the present invention; and

FIG. 3 is a side close-up view of a portion of an embodiment of the system according to the present invention.

### DETAILED DESCRIPTION

The webs usable in the present invention include paper, fabrics, films, felts, scrims, and other rolled material and roll composites. The present invention is especially suitable for the processing of synthetic materials such as thermoplastic materials which are used as building wraps, synthetic roof underlayments, fence liners, tarps, industrial wraps, insulation and sheathing materials. As thermoplastic web materials, polyolefins such as polypropylene and polyethylene are especially preferred.

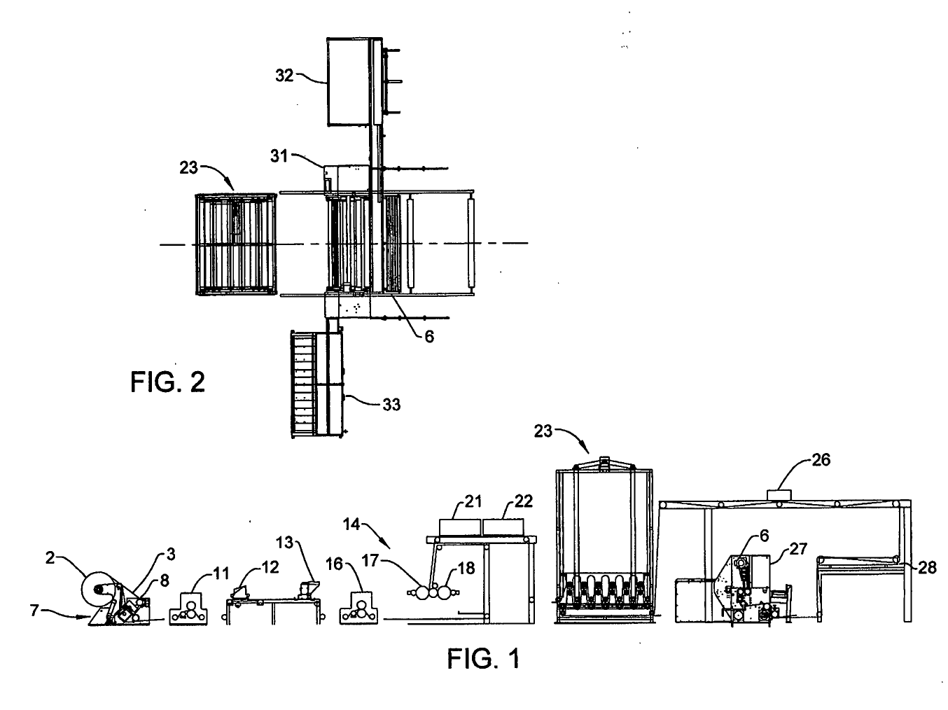

The parent roll web width that can be processed by the present invention is not limited and can range from approximately 34 inches to 124 inches and the master rolls to be unwound is also not limited and can have a diameter of up to 72 inches. As illustrated in FIG. 1, where an embodiment of the system 1 according to the present invention is shown, a large parent roll 2 of a web material is placed on an unwinder 7. The web 3 is pulled from the unwinder 7 by a first pull nip 11. The feed speed of the web 3 can be controlled to cause stretching of the web.

In the illustrated system 1, the web 3 is fed through a surface treatment station 8, such as corona treatment equipment, plasma treatment equipment or flame or aqueous primer applying equipment, to prepare the surface of the web 3 to accept inks and coatings. After being subjected to the surface treatment at the surface treatment station 8, the web enters into a digital printer 12. The digital printer can be any known digital printer used for printing on webs and utilizes an ink, such as UV-, EB, solvent or waterbased ink, and digital ink-jet equipment. This allows the ability to alternate the printed artwork and colors during operation without the need for plate or ink changes. This also assists in reducing a minimum ordering quantity now required in conventional web printing to make the process economically feasible.

After leaving the digital printer 12, the web having the printed material thereon passes through a fuser or curer for the ink, such as a UV lamp or oven, to permanently affix the printing onto the web material.

The web then enters a printing station 14 (or other image/plate transfer system) which utilizes flexographic, gravure or any other type of in-line printers. The illustrated printing station 14 comprises first and second flexographic printers 17, 18. The two flexographic printers 17, 18 are capable of printing one color each in two different lanes of print or providing two different colored stations for two color images in the same lane or placing printing heads next to each other to provide a wider one color image or coating. Water-based inks, solvent-based inks, UV-curable inks and electron beam-curable inks can be used for the flexographic printing. After receiving printing at the flexographic printing station 14, the web then travels to a means for curing or drying the applied ink such as first and second driers 21, 22. The first and second driers 21, 22 are used when the ink applied at the flexographic printing station 14 is a water-based or solvent-based ink. If an ultraviolet- or electron beam-curable ink is used instead, then the first and second driers 21, 22 can be substituted by ultraviolet- or electron beam-curing devices.

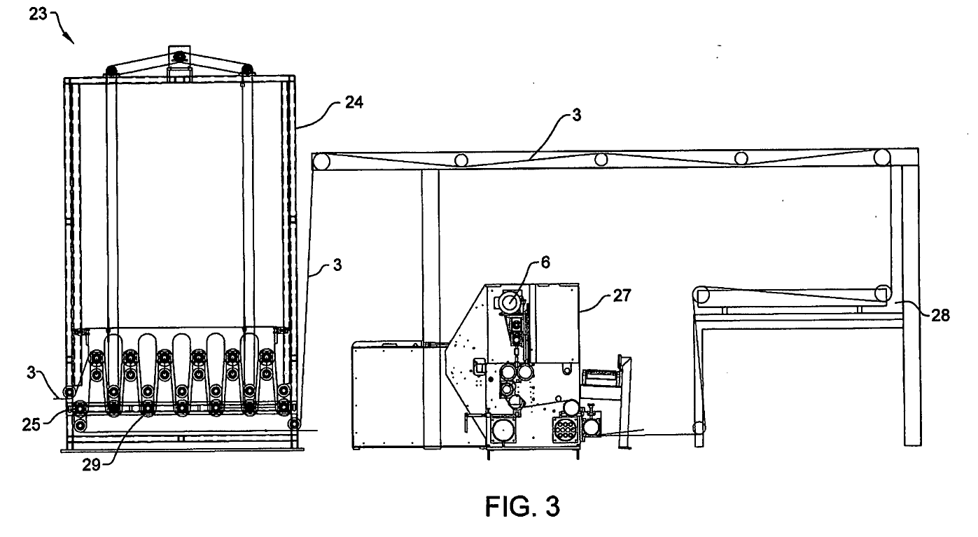

After exiting the first and second driers 21, 22, the web 3 enters an accumulator 23. As shown in FIGS. 2 and 3, is used to control the tension 23. The accumulator can be modified to hold more or less material depending on the process's needs. The speed and tension of the web 3 entering and exiting the accumulator are controlled by a controller to allow at least one processing step be performed on the web continuously 3, such as printing, prior to entering the accumulator 23 and the web 3 to be wound into a smaller roll 6 after exiting the accumulator 23.

As shown in FIG. 1, another processing member 26, such as a perforator, can be provided to perform an additional processing step on the web 3 after it exits the accumulator 23. A web steering unit 28 can be optionally provided to align the web 3 prior to entering the rewinder 27. The rewinder 27 winds the web 3 to a desired roll length, stops pulling the web at a desired point, cuts the web, finally winds the web up on the small diameter roll, tapes or seals the tail of the web, ejects the roll 6, is loaded with a new empty core roll from the core loader 33, loads the web over the core roll, tucks the web in and starts winding/pulling the material again to wind the next roll. This happens while the material behind the accumulator continues to process and run.

The ejected roll passes through a printer and labeling station 31 where printing is applied to a label indicative of the printing applied to the web at the earlier printing stations and the label is applied to the ejected roll. The small roll 6 is then fed to a stacking table 32 where the rolls are manually stacked onto a pallet or boxed for delivery.

While the present invention has been described with respect to a particular embodiment, it would be apparent to one of ordinary skill in the art that it is not so limited and is capable of being changed in various manners without departing from the scope of the present invention.

What is claimed is:

1. In a method of continuously transferring a web of material from a large roll to a small roll, the improvement comprising performing at least one processing step including printing on the web of material during the continuous transfer of the web of material from the large roll to the small roll.

2. The method of claim 1, wherein the at least one processing step comprises a step of subjecting a surface of the web of material to a corona discharge.

3. The method of claim 1, wherein the at least one processing step comprises a step of perforating the web of material.

4. The method of claim 1, wherein the at least one processing step comprises a step of printing on the surface of the web of material.

5. The method of claim 1, wherein the at least one processing step comprises a step of stretching the web of material.

6. The method of claim 4, wherein the step of printing is performed by a digital printer.

7. The method of claim 4, wherein the step of printing is performed by a flexographic printer or another image/plate transfer system.

8. The method of claim 4, wherein the step of printing is performed by a combination of digital and flexographic printers.

9. The method of claim 1, additionally comprising a step of applying a label to the small roll.

10. The method of claim 9, additionally comprising the step of printing on the label prior to it being applied to the small roll.

11. The method of claim 1, wherein at least one processing step comprises forming a seam in the web of material.

12. The method of claim 1, wherein the web of material is made of a thermoplastic.

13. The method of claim 1, wherein the web of material passes through an accumulator during its continuous transfer from the large roll to the small roll.

14. A system for continuously transferring a web of material from a large roll to a small roll while performing at least one processing step including printing on the web of material, comprising: unwinding means for removing the web of material from the large roll; means for transferring the web of material from the unwinding means to at least one processing station; at least one processing station for performing at least one processing step including printing on the web of material; an accumulator for controlling the tension of the web of material during the performing of the at least one processing step; and a winding means for transferring the web of material having the at least one processing step performed thereon to the small roll.

15. The system of claim 14, wherein the at least one processing station comprises means for subjecting the web of material to a corona discharge.

16. The system of claim 14, wherein the at least one processing station comprises means for perforating the web of material.

17. The system of claim 14, wherein the at least one processing station comprises means for printing on the surface of the web of material.

18. The system of claim 17, wherein the means for printing on the surface of the web of material is a digital printer.

19. The system of claim 17, wherein the means for printing on the surface of the web of material is a flexographic printer.

20. The system of claim 17, wherein the means for printing on the surface of the web of material is a combination of digital and flexographic printers.

21. The system of claim 14, wherein the at least one processing station comprises means for applying a label to the small roll.

22. The system of claim 21, additionally comprising means for printing on the label prior to it being applied to the small roll.

23. The system of claim 14, wherein the at least one processing station comprises means for forming a seam at the web of material.
